(19) United States
(12) Patent Application Publication
(10) Pub. No.: US 2008/0110138 A1
(43) Pub. Date: May 15, 2008

(54) CSI flex-plate system

(76) Inventors: Kevin Helms, Creighton, MO (US); Donna Helms, Creighton, MO (US)

Correspondence Address: Kevin & Donna Helms, 100 Old 7 Highway, Suite 4, P.O. Box 73, Garden City, MO, 64747, US

(21) Appl. No.: 11/509,099

(22) Filed: Oct. 19, 2006

(51) Int. Cl. B68B 1/12

(52) U.S. Cl. 54/66

(57) ABSTRACT

The CSI flex-plate is a special design technology that will help disburse the pressure over a greater area on the horse whether it be the back of the horse or other parts, thus reducing pressure points and reducing discomfort for both horse and rider. By cutting, layering and bonding a polycarbonate polymer into a combination of different lengths, shapes and thickness to achieve maximum performance, comfort, and protection at equestrian stress points. Currently the plate is sewn into saddle pads at the withers, along the spine, to the flanks, creating a base for the saddletree to rest upon, creating a stable foundation, which distributes the weight of the rider and saddletree pressure evenly over the horse's back. This distribution system will allow the horse to be more balanced, and have freer range of motion, thereby eliminating pain and sore spots. Improving the overall performance, attitude and endurance of the horse. This technology increases comfort and stability of the horse, rider and saddle.

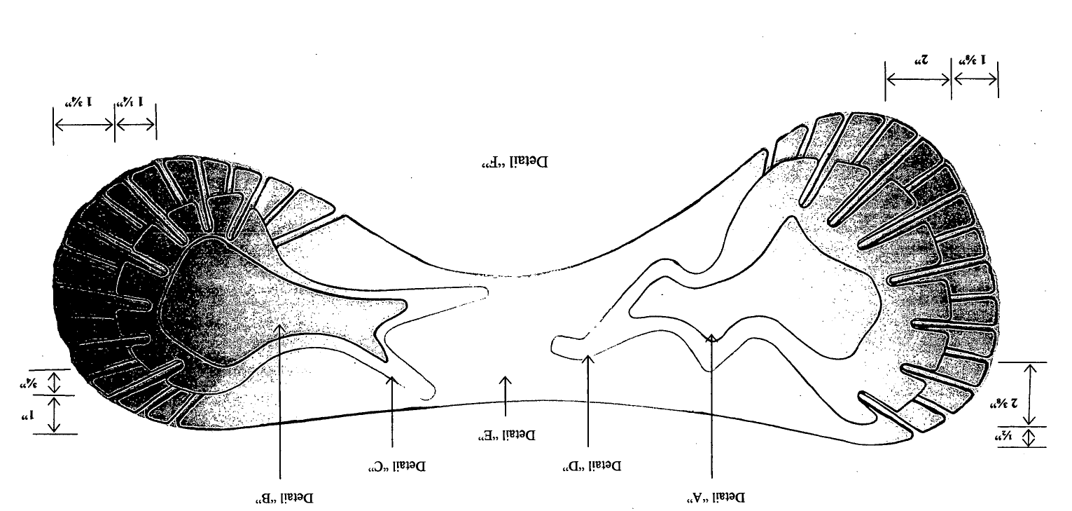

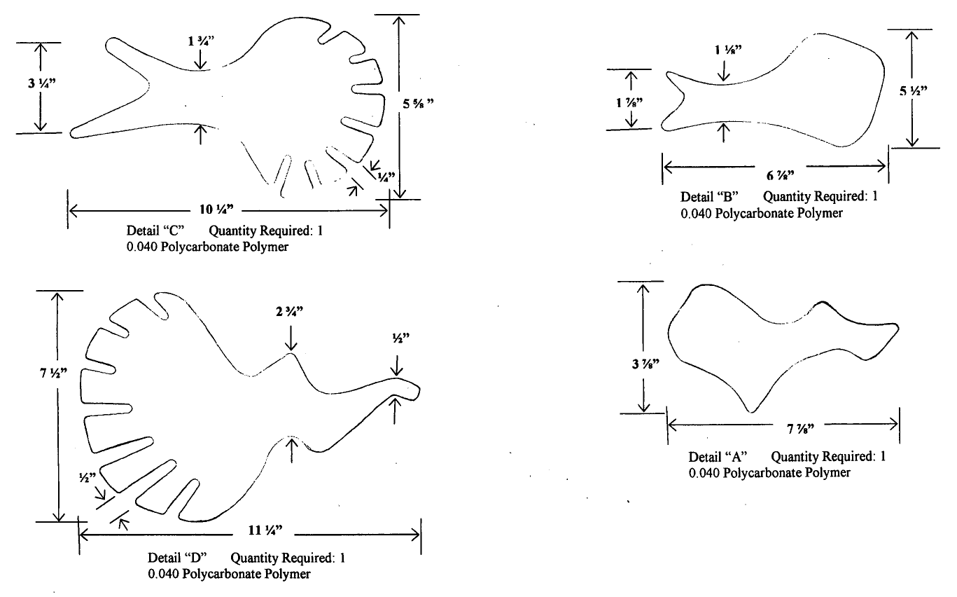

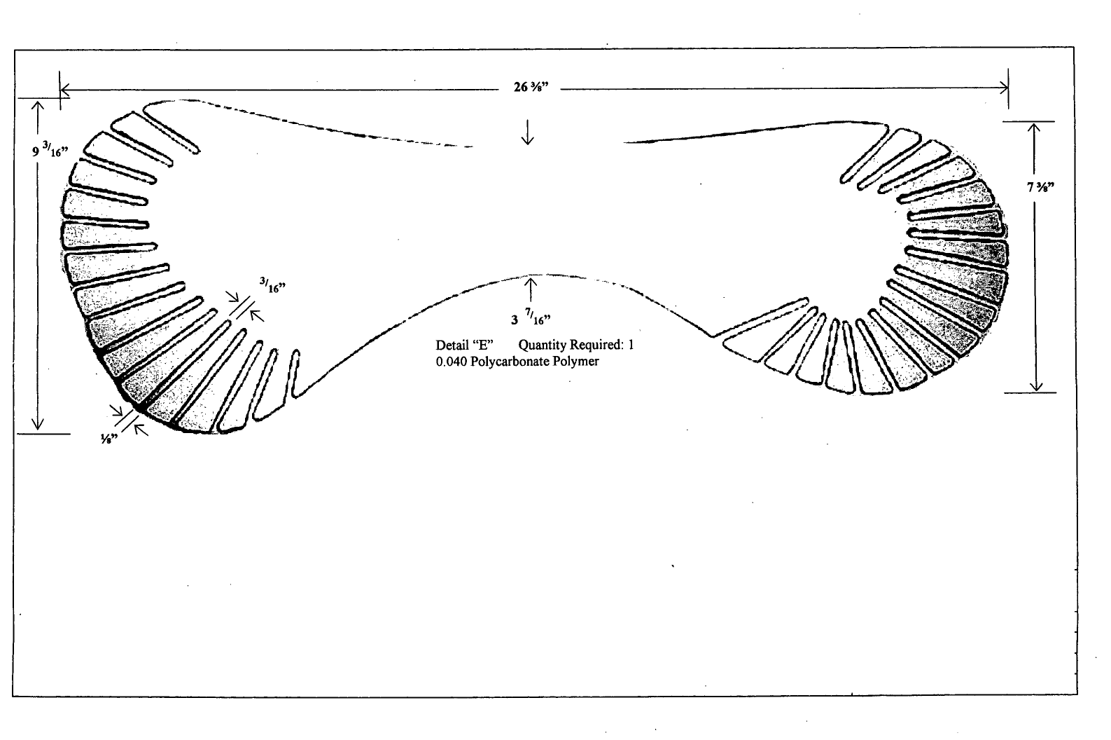

### DESCRIPTION OF VIEWS OF DRAWINGS

The CSI Flex-Plate is a special design, cutting and layering Polycarbonate Polymer, into a combination of different lengths and thickness to achieve maximum performance, endurance, comfort, and protection at equestrian stress point targets. Currently the plate is sewn into saddle pads at the wither, along the spine, to the flanks. This technology increases comfort and stability of the horse, rider and saddle. The CSI Flex-Plate is a big innovation in pad technology.

The CSI Flex-Plate System as shown in these drawings is made up of five pieces of 0.040-polycarbonate polymer (Details “A”, “B”, “C”, “D”, & “E”) that are chemically bonded into three layers. Detail “E”, drawing number 1000, sheet 3 of 3, is the bottom layer. Details “C” & “D”, drawing number 1000, sheet 2 of 3, comprise the middle layer, and detail “A” & “B”, drawing number 1000, sheet 2 of 3, make the top layer. Drawing 1000, Sheet 1 of 3, detail “F”, shows the completed assembly.

I claim:

1. A CSI Flex-Plate article of horse equipments that brings maximum performance comfort and protection at all stress points is a special design cut and layering of polycarbonate polymer, into multitudes of combinations of different lengths, shapes and thickness:
(a) pieces of polycarbonate polymer
(b) chemical bonding material used to bond pieces of said polycarbonate polymer into layers
(c) other materials at least, leather, carpet, wool and foam sewn around said polycarbonate polymer.
